(19) United States
(12) Patent Application Publication
(10) Pub. No.: US 2026/0015231 A1
(43) Pub. Date: Jan. 15, 2026

(54) SYSTEM AND METHOD FOR IMPROVING CHEMICAL YIELD FROM GASIFICATION VIA HYDROGEN SUPPLEMENTATION

(71) Applicant: University of Florida Research Foundation, Inc., Gainesville, FL (US)

(72) Inventor: Bruce WELT, Gainesville, FL (US)

(21) Appl. No.: 18/995,222

(22) PCT Filed: Jul. 25, 2023
(86) PCT No.: PCT/US2023/070881

§ 371 Date: Jan. 16, 2025

Related U.S. Application Data
(60) Provisional application No. 63/394,500, filed on Aug. 2, 2022.
(60) Provisional application No. 63/370,691, filed on Aug. 8, 2022.

(51) Int. Cl. C01B 3/10; C01B 3/08; C01B 3/34; C01F 7/56

(52) U.S. Cl. CPC C01B 3/10; C01B 3/08; C01B 3/34; C01F 7/56; C01B 2203/0205; C01B 2203/061; C01B 2203/1241

(57) ABSTRACT

In one aspect, the disclosure relates to a method for supplementing syngas to produce a precursor composition for synthesis of at least one industrially useful chemical, the method comprising contacting the syngas with an external source of hydrogen. In an aspect, industrially useful chemical comprises methanol and the external source of hydrogen comprises hydrogen produced by steam methane reforming (SMR), hydrogen produced by steam injected onto molten metals, or another hydrogen source. In some aspects, the external source of hydrogen comprises hydrogen produced by a halogen acid contacting scrap metal, wherein the halogen acid can be produced by gasifying a halogen-containing polymer such as, for example, polyvinylchloride (PVC), polyvinylidene chloride (PVDC), or any combination thereof. Also disclosed herein are systems useful for carrying out the disclosed methods.

### CROSS REFERENCE TO RELATED APPLICATIONS

This application claims the benefit of and priority to U.S. Provisional Application No. 63/370,691, filed on Aug. 8, 2022, and U.S. Provisional Application No. 63/394,500, filed on Aug. 2, 2022, both of which are expressly incorporated by reference as if fully set forth herein in their entireties.

### BACKGROUND

Gasification is a process commonly used to convert biomass or other organic materials into gases, which can in turn be used as fuels or feedstocks for production of useful chemicals including, but not limited to, methanol. Gasification is growing in popularity as an alternative to depositing waste materials in landfills and/or incinerating them, as gasification typically results in lower levels of release of atmospheric pollutants. Gasification conducted on biomass is, in some instances, considered a renewable energy process, since biomass production consumes atmospheric carbon dioxide.

The primary product of gasification is synthesis gas which is a mixture of CO and H₂ with small amounts of CO₂, N₂, methane, and related components in small amounts. The primary product of gasification processes is syngas (i.e., CO and H₂), which has numerous uses in industry. One such use is as a precursor to organic chemicals including, but not limited to, methanol. When making methanol, the ratio of H₂ to CO must be greater than 2:1, but syngas leaving a gasifier typically has an H₂ to CO ratio of 1:1. A typical strategy to adjust the H₂ to CO ratio is to pass the syngas through a water-gas-shift (WGS) reactor, which reacts water, typically in the form of steam with syngas to convert some of the CO to CO₂, in turn liberating H₂ and adjusting the H₂ to CO ratio. However, performing this step is economically expensive and, further, sacrifices methanol yield due to loss of CO.

Despite advances in gasifier research and development, there is still a scarcity of systems and methods for gasifying carbon-based materials that produce desirable H₂ to CO ratios for further organic chemical production. An ideal system and/or method would also optimize chemical product yield and minimize CO loss while reducing operating and capital costs. These needs and other needs are satisfied by the present disclosure.

### SUMMARY

In accordance with the purpose(s) of the present disclosure, as embodied and broadly described herein, the disclosure, in one aspect, relates to a method for supplementing syngas to produce a precursor composition for synthesis of at least one industrially useful chemical, the method comprising contacting the syngas with an external source of hydrogen. In an aspect, industrially useful chemical comprises methanol and the external source of hydrogen comprises hydrogen produced by steam methane reforming (SMR), hydrogen produced by steam injected onto molten metals, or another hydrogen source. In some aspects, the external source of hydrogen comprises hydrogen produced by a halogen acid contacting various types of metals, wherein the halogen acid can be produced by gasifying a halogen-containing polymer such as, for example, polyvinylchloride (PVC), polyvinylidene chloride (PVDC), or any combination thereof. Also disclosed herein are systems useful for carrying out the disclosed methods.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows an exemplary system and method according to one embodiment of the present disclosure. The box in the lower right corner represents the gasification process. Also shown is one way to produce hydrogen according to one embodiment of the present disclosure. In this embodiment, a molten metal furnace can be used where water in the form of steam is permitted to react and oxidize molten metal. The molten state of metal facilitate a reaction where water oxidizes metal, forming metal oxides while liberating energy and H₂. In the system depicted, the resulting H₂ is being added to syngas. In some embodiments, hydrogen would be pressurized in a surge tank and then metered into the syngas to create the optimum H₂ to CO ratio desired. At landfills, there is access to abundant scrap metals to feed this reaction to produce hydrogen.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Disclosed herein is a method for supplementing syngas to produce a precursor composition for synthesis of at least one industrially useful chemical, the method including at least the step of contacting the syngas with an external source of hydrogen.

In some aspects, the syngas includes H₂ and CO in a molar ratio of about 1:1. In another aspect, the precursor composition includes H₂ and CO in a molar ratio of at least 2:1. In any of these aspects, the industrially useful chemical can be methanol.

In one aspect, the external source of hydrogen can be hydrogen produced by steam methane reforming (SMR). In some aspects, the SMR can be conducted on methane collected from a landfill. In another aspect, the external source of hydrogen can be hydrogen produced by steam injected onto molten metals. In some aspects, the molten metals can be obtained by heating scrap metal.

In still another aspect, the external source of hydrogen can be hydrogen produced by a halogen acid contacting scrap metal. In some aspects, the halogen acid can be produced by gasifying a halogen-containing polymer. In one aspect, the halogen-containing polymer can be polyvinylchloride (PVC), polyvinylidene chloride (PVDC), or any combination thereof. In another aspect, the halogen acid can be HCl, HF, or any combination thereof. In some aspects, the method further produces a metal halogen such as, for example, aluminum chloride.

In any of these aspects, the method does not use a water-gas-shift (WGS) reactor. Also disclosed herein are precursor compositions produced by the disclosed method.

In another aspect, disclosed herein is a system including a furnace and a source of steam or water wherein, in the furnace, metals are melted and contacted with the steam or water to produce metal oxides and hydrogen gas. The metal oxides can be any industrially useful metal oxides including, but not limited to, aluminum oxide, copper oxide, tin oxide, iron oxide, or the like. The metal oxides can include a single oxidation state of a given metal (e.g. iron (II) oxide) or can be combinations of metal oxides where the metal is in more than one oxidation state (e.g. mixed iron (II) and iron (III) oxide). In one aspect, the metal oxides can be collected and used for further industrial uses including, but not limited to, catalysis, metal-oxide based pigments, production of nanoparticles and other nanomaterials, in sensors, in energy applications, and the like. In a further aspect, the disclosed system further includes a condenser for condensing steam or water vapor to a water condensate and separating the water condensate from the hydrogen gas.

In one aspect, the system further includes a gasifier, wherein the gasifier produces syngas from a biomass source or a fuel source. In one aspect, the biomass source can be municipal solid waste (MSW). In still another aspect, the hydrogen gas produced by the system can be added to the syngas. In any of these aspects, the metals can be scrap metals.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a metal,” “a halogen,” or “a biomass source,” includes, but is not limited to, mixtures or combinations of two or more such metals, halogens, or biomass sources, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y.’ The range can also be expressed as an upper limit, e.g. ‘about x, y, z, or less’ and should be interpreted to include the specific ranges of ‘about x,’ ‘about y’, and ‘about z’ as well as the ranges of ‘less than x’, less than y′, and ‘less than z’. Likewise, the phrase ‘about x, y, z, or greater’ should be interpreted to include the specific ranges of ‘about x,’ ‘about y,’ and ‘about z’ as well as the ranges of ‘greater than x,’ greater than y,' and ‘greater than z.’ In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a metal refers to an amount that is sufficient to achieve the desired improvement in the property modulated by the formulation component, e.g. achieving the desired level of hydrogen production. The specific level in terms of wt % in a composition required as an effective amount will depend upon a variety of factors including the amount and type of metal, amount and type of halogen-containing plastics being used, if any, amount and type of contaminants present on the metal, and desired chemical products and yields thereof from the disclosed reactions.

As used herein, the terms “optional” or “optionally” means that the subsequently described event or circumstance can or cannot occur, and that the description includes instances where said event or circumstance occurs and instances where it does not.

As used herein, a “gasifier” is an apparatus that uses a carbon-containing fuel such as biomass or a fossil fuel to gases such as, for example, syngas, or gas mixtures including syngas.

As used herein, “syngas” is a combustible fuel including hydrogen and carbon monoxide as well as trace amounts of other gases such as carbon dioxide, methane, nitrogen, and the like.

“Steam methane reforming” or “SMR” refers to a method for producing syngas by reacting hydrocarbons with water. In some aspects, natural gas can be used as a feedstock. SMR is typically conducted at high temperature and pressure and is a highly endothermic process that can be made more environmentally benign by powering the process with renewable energy resources.

A “halogen” as used herein refers to a group 17 element in the periodic table. Common halogens include fluorine, chlorine, bromine, and iodine.

Meanwhile, a “halogen-containing polymer” refers to a polymer that includes a polymeric material in which at least a portion of hydrogen atoms are replaced with halogen atoms. Halogen-containing polymers include, but are not limited to, polyvinyl chloride (PVC) and polyvinylidene chloride (PVDC).

“Municipal solid waste” or “MSW” is commonly also referred to as “trash” or “garbage” such as household waste or food waste discarded by the public and typically taken to a landfill. In one aspect, MSW can be a source of biomass that can be gasified and used in the methods disclosed herein. In a further aspect, biomass present in MSW can include, but is not limited to, yard waste, food waste, or another biological waste product produced through household or commercial use.

“Scrap metals” refers to metals that have been discarded and/or that can be reprocessed. In some aspects, scrap metals are left over from manufacturing, consumption, or the like. In an aspect, scrap metals useful herein can be pure metals or alloys, and include, but are not limited to, aluminum, iron, steel, brass, nickel, tin, lead, copper, zinc, bronze, and combinations thereof.

Unless otherwise specified, temperatures referred to herein are based on atmospheric pressure (i.e. one atmosphere).

### Exemplary System for Producing Syngas

In one aspect, systems known in the art for producing syngas can be used in conjunction with the disclosed systems and methods for supplementing syngas. In one such system, an induction furnace is the lower portion of a hermetically sealed gasification unit, which provides for feeding shredded mixed solid waste in a hermetically sealed manner. In a further aspect, saturated and/or superheated steam can sparged into the molten metal/slag charge within the induction furnace, although in some embodiments, steam is not required. In an aspect, when steam is used, steam can provided from boiler conditions optimized for capital and operating efficiency, likely the highest realistic temperatures from standard boiler equipment. In some aspects, tangential introduction of forced steam at a downward angle promotes mixing and rotation of the molten metal. Without wishing to be bound by theory, by moving the molten metal conductor through the magnetic field of the induction furnace, a dynamo effect is created. In a further aspect, steam energy can be converted into thermal energy within the furnace, reducing process power consumption. In one aspect, according to some embodiments of the present disclosure, a flooded hydrolytic lock system can be used instead. In another aspect, for larger systems a compression feed screw should function ideally. In one aspect, the disclosed systems and methods are compatible with various pressure regimes. In a further aspect, prototypes and smaller-scale units can successfully operate at atmospheric pressure or at a slight vacuum, but economic advantages can be attained by operating larger-scale gasifiers at elevated pressures, thus eliminating the need for syngas compression. In an aspect, syngas leaving the gasifier can contain tars and particulates. In a further aspect, clean-up of the syngas produced can be accomplished a small plasma unit, cyclone filters, or both.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Aspects

The present disclosure can be described in accordance with the following numbered Aspects, which should not be confused with the claims.

Aspect 1. A method for supplementing syngas to produce a precursor composition for synthesis of at least one industrially useful chemical, the method comprising contacting the syngas with an external source of hydrogen.

Aspect 2. The method of aspect 1, wherein the syngas comprises H₂ and CO in a molar ratio of about 1:1.

Aspect 3. The method of aspect 1 or 2, wherein the precursor composition comprises H₂ and CO in a molar ratio of at least 2:1.

Aspect 4. The method of any one of aspects 1-3, wherein the at least one industrially useful chemical comprises methanol.

Aspect 5. The method of any one of aspects 1-4, wherein the external source of hydrogen comprises hydrogen produced by steam methane reforming (SMR).

Aspect 6. The method of aspect 5, wherein the SMR is conducted on methane collected from a landfill.

Aspect 7. The method of any one of aspects 1-4, wherein the external source of hydrogen comprises hydrogen produced by steam injected onto molten metals.

Aspect 8. The method of aspect 7, wherein the molten metals are obtained by heating scrap metal.

Aspect 9. The method of any one of aspects 1-4, wherein the external source of hydrogen comprises hydrogen produced by a halogen acid contacting scrap metal.

Aspect 10. The method of aspect 9, further comprising producing the halogen acid by gasifying a halogen-containing polymer.

Aspect 11. The method of aspect 10, wherein the halogen-containing polymer comprises polyvinylchloride (PVC), polyvinylidene chloride (PVDC), or any combination thereof.

Aspect 12. The method of any one of aspects 9-11, wherein the halogen acid comprises HCl, HF, or any combination thereof.

Aspect 13. The method of any one of aspects 9-12, wherein the method further produces a metal halogen.

Aspect 14. The method of aspect 13, wherein the metal halogen comprises aluminum chloride.

Aspect 15. The method of any one of aspects 1-14, wherein the method does not use a water-gas-shift reactor.

Aspect 16. A precursor composition produced by the method of any one of aspects 1-15.

Aspect 17. A system comprising:
(a) a furnace; and
(b) a source of steam or water;
wherein, in the furnace, metals are melted and contacted with the steam or water to produce metal oxides and hydrogen gas.

Aspect 18. The system of aspect 17, further comprising a condenser for condensing steam or water vapor to a water condensate and separating the water condensate from the hydrogen gas.

Aspect 19. The system of aspect 17 or 18, further comprising a gasifier, wherein the gasifier produces syngas from a biomass source or a fuel source.

Aspect 20. The system of aspect 19, wherein the biomass source comprises municipal solid waste.

Aspect 21. The system of aspect 19 or 20, wherein the hydrogen gas produced by the system is added to the syngas.

Aspect 22. The system of any one of aspects 17-21, wherein the metals are scrap metals.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Hydrogen Production Processes Useful With the Disclosed System and Method

Various processes can be used to produce hydrogen for syngas supplementation in the method described herein.

Steam Methane Reforming: Landfills produce methane, so steam methane reforming can be used to produce hydrogen in conjunction with a disclosed system installed at the site of a landfill.

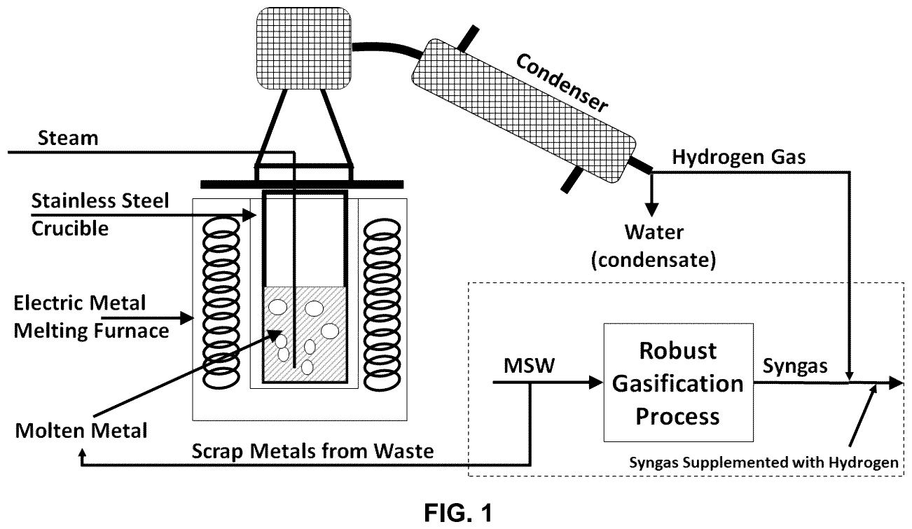

Reaction of Metals with Steam and/or Water: As described with respect to FIG. 1, steam and, in some cases, water injected into molten metals produces metal oxides and hydrogen.

Reaction of Halogen Acids with Metals: Polymers including polyvinylchloride (PVC) and barrier polymers including polyvinylidene chloride (PVDC) are being phased out of industry due to challenges with recycling and incineration of these materials. In a typical robust gasification process, halogens including chlorine and fluorine become acids such as HCl and HF, respectively. In typical processes, these acids can be neutralized with bases such as, for example, lye (NaOH), to produce salts such as, for example, NaCl, which are safe to discharge. However, when scrap metals are present in the disclosed process, syngas incorporating acidic components such as these can be passed over shredded scrap metals to produce metal halogens including, but not limited to, aluminum chloride, as well as hydrogen. In many cases, the metal halogens are, themselves, useful as catalysts or in industrial processes. Thus, the disclosed process improves recycling efficiency of polymers that have traditionally been difficult to recycle.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A method for supplementing syngas to produce a precursor composition for synthesis of at least one industrially useful chemical, the method comprising contacting the syngas with an external source of hydrogen.

2. The method of claim 1, wherein the syngas comprises H₂ and CO in a molar ratio of about 1:1.

3. The method of claim 1, wherein the precursor composition comprises H₂ and CO in a molar ratio of at least 2:1.

4. The method of claim 1, wherein the industrially useful chemical comprises methanol.

5. The method of claim 1, wherein the external source of hydrogen comprises hydrogen produced by steam methane reforming (SMR), wherein the SMR is conducted on methane collected from a landfill.

6. (canceled)

7. The method of claim 1, wherein the external source of hydrogen comprises hydrogen produced by steam injected onto molten metals.

8. The method of claim 7, wherein the molten metals are obtained by heating scrap metal.

9. The method of claim 1, wherein the external source of hydrogen comprises hydrogen produced by a halogen acid contacting scrap metal.

10. The method of claim 9, further comprising producing the halogen acid by gasifying a halogen-containing polymer.

11. The method of claim 10, wherein the halogen-containing polymer comprises polyvinylchloride (PVC), polyvinylidene chloride (PVDC), or any combination thereof.

12. The method of claim 9, wherein the halogen acid comprises HCl, HF, or any combination thereof.

13. The method of claim 9, wherein the method further produces a metal halogen.

14. The method of claim 13, wherein the metal halogen comprises aluminum chloride.

15. The method of claim 1, wherein the method does not use a water-gas-shift reactor.

16. (canceled)

17. A system comprising:
(a) a furnace; and
(b) a source of steam or water;
wherein, in the furnace, metals are melted and contacted with the steam or water to produce metal oxides and hydrogen gas.

18. The system of claim 17, further comprising a condenser for condensing steam or water vapor to a water condensate and separating the water condensate from the hydrogen gas.

19. The system of claim 17, further comprising a gasifier, wherein the gasifier produces syngas from a biomass source or a fuel source.

20. The system of claim 19, wherein the biomass source comprises municipal solid waste.

21. The system of claim 19, wherein the hydrogen gas produced by the system is added to the syngas.

22. The system of claim 17, wherein the metals are scrap metals.
